(19) United States
(12) Patent Application Publication
(10) Pub. No.: US 2025/0178384 A1
(43) Pub. Date: Jun. 5, 2025

(54) A VALVE STEM AND VALVE SYSTEM AND SEALANT APPLICATION TOOL FOR A TUBELESS TYRE SETUP

(71) Applicant: Greenpath B.V., Stevensbeek (NL)

(72) Inventors: Eugène Antoine Adriaan HERBEN, Stevensbeek (NL); Gertjan VAN GINDEREN, Stevensbeek (NL)

(21) Appl. No.: 18/840,728

(22) PCT Filed: Feb. 23, 2023
(86) PCT No.: PCT/NL2023/050088

§ 371 Date: Aug. 22, 2024

(30) Foreign Application Priority Data
Feb. 24, 2022 (NL) 2031063

(51) Int. Cl. B60C 29/00

(52) U.S. Cl. CPC B60C 29/002; B60C 29/005

(57) ABSTRACT

A valve stem system for a tubeless tire setup for a wheel including a rim and a tire. The valve stem system includes a valve stem body having at a first end an outer valve stem configured to receive a valve core, and at a second end an inner valve body extending in an air reservoir defined between the rim and the tire. A first valve allows air passage between the valve core and the air reservoir. A second valve at the inner valve body allows sealant passage from the outer valve stem into the air reservoir. A filter disposed between the first valve and the air reservoir filters sealant from the air reservoir to enter the first valve. The first valve is a movable non-return valve body disposed in the valve stem body and configured for longitudinal displacement.

### BACKGROUND OF THE INVENTION

The present invention is directed to a valve stem system for a tubeless tyre setup, e.g. for bicycle wheels.

The present invention is further directed to a sealant application tool for inserting sealant into such a valve stem system for tubeless tyre setups.

Valve stem systems are commonly used tyre valve systems used on all types of motorized or non-motorized vehicles, for example on tyres of cars but also on tyres of a bicycle and are for example shown in EP 3 107 742 B1, U.S. Pat. Nos. 4,462,449 A, 5,479,975 A, AU 694 671 B2, CN 201 659 858 U.

Tubeless tyres have several advantages over such traditional designs with an inner tube as they have less weight, and consequently better dynamic behaviour, less rolling resistance, and a significantly lower risk of punctures and flat tyres because of the self-sealing properties. Tubeless tyres however also have disadvantages as they for example have a more difficult mounting procedure, they should be suitable for an inflation procedure of the tyre by so-called tyre boosting. Boosting is known as the procedure to get the tyre seated neatly in the rim, such that it is on the right position and gastight.

Tubeless tyres typically use tyre sealants which is cumbersome to use. This sealant is necessary to create a gastight seal between the tyre and the rim and to instantly repair a leakage caused by a punctured tyre.

Typically, sealant can be added in two ways. The first method is to pour the sealant inside the tyre before the tyre is mounted onto the rim. This has the disadvantage that the bead of the tyre must be fitted onto the rim again, which is inconvenient and creates a mess, especially when the tyre is already mounted and the sealant must be added afterwards, this is cumbersome and difficult method, as the tyre needs to be sealed gastight to the rim again and again. The second, preferred and most common method is to add sealant directly through the valve core, such as a Presta valve, after the tyre is fitted onto the rim. For this method compatible valve stem systems and sealant injection tools are required. Such known valve stem systems and corresponding sealant injection tools typically use a syringe to which an injection hose is attached by which the sealant is injected into the tyre. These known systems and methods have several disadvantages.

First, the boosting procedure of the tyre is difficult due to restricted air passage or loss of air pressure directly after boosting (through the valve). Second, there is a risk of sealant entering the valve stem and blocking the passage during normal use. Third, there is a risk of sealant entering the valve stem while deflating the tyre. And fourth, there is a risk of sealant entering the valve stem during injecting or retracting sealant, e.g. when checking the condition and amount of remaining sealant:

From these disadvantageous, the second, third and fourth make (re-)inflating the tyre very difficult or even impossible as the valve does not open properly anymore. Moreover, particles inside the sealant may prevent the valve from closing properly, leading to leakage and flat tyres.

Accordingly, there is a need for an improved valve stem system for a tubeless tyre setup in which at least one or more of the above mentioned drawbacks are obviated.

### SUMMARY OF THE INVENTION

In a first aspect of the present disclosure, there is provided, a valve stem system for a tubeless tyre setup, said wheel comprising a rim and a tyre, said valve stem system comprising:
a valve stem body comprising at a first end an outer valve stem arranged for receiving a valve core, and at a second end an inner valve body extending in an air reservoir defined between said rim and said tyre when said tyre is mounted on said wheel;
a first valve, comprising a valve outlet port at said inner valve body, configured to allow air passage between said outer valve stem and said air reservoir;
a second valve, comprising a valve outlet which at said inner valve body, separate from said outlet port of said first valve, configured to allow sealant passage from said outer valve stem into said air reservoir; said valve stem system further comprising:
a filter, disposed between said first valve and said air reservoir, to filter sealant from said air reservoir to enter said first valve;
   wherein said first valve is configured as a movable non-return valve body which is disposed in said valve stem body, and configured for longitudinal displacement within said valve stem body upon receiving said valve core in said outer valve stem, for said first valve to open and allow air passage between said valve core and said air reservoir.

A valve stem system is a valve system for inflating (and deflating) tyres of wheeled vehicles. In accordance with the present disclosure, the proposed valve system is thus also arranged and configured for all types of wheeled vehicles, for example, but not limited to, two-wheeled vehicles, three-wheeled vehicles, four-wheeled vehicles or multi-wheeled vehicles for example used for all-terrain or military applications. The proposed system may be used in a motorized or non-motorized vehicle, but is preferably arranged for bicycle tyres.

As mentioned, tubeless tyre setups have several advantageous over inner-tube tyres setups having inner-tubes, but the tubeless versions have different and more complex inflation procedures, i.e. tyre boosting. They also require or at least highly recommend the use of a sealant to create a gastight seal between the tyre and the rim and to instantly repair a leakage caused by a punctured tyre.

The sealant may be applied directly into the inside of the tyre, which requires partly or full removal of the tyre from the rim, making such application cumbersome and messy.

The sealant may however also be applied when the tyre is already installed on the rim, in which case the sealant is inserted into the inside of the tyre trough the valve system.

As such a valve system should be arranged for inflating (and deflating) the air within the tyre, but also be arranged for inserting sealant through the valve system without leakage from the tyre.

The proposed valve stem system is able to fulfil both tasks of allowing air in and out of the tyre, as well as on the one hand allowing sealant into the tyre (and, if required, optionally also with a sealant application tool out of the tyre) while on the other hand, sealant is prevented from entering or clogging the valve stem system when the sealant application tool is not in the valve stem system and the valve stem is thus in use.

The valve stem system according to the present disclosure is, as indicated, arranged for a tubeless tyre setup, which wheel comprises a rim and a tyre. The system comprises a valve stem body. The valve stem body is defined as a component that can be placed into a bore in the rim and may comprise but in accordance with the present disclosure is arranged for receiving a standardized valve component, also referred to as a valve core. The valve core can be any standardized valve, such as, but not limited to a Presta valve or any other valve. The valve core can however also comprise an interface for a tyre pressure management system. The valve stem body thus, amongst others, has a function of providing an interface to a Presta, or similar valve.

The valve stem body comprises two parts which are preferably detachable, but may alternatively also be integrated into a single monolithic component. These two components are the rim part and a cylindrical part, or also referred to as an outer valve stem (cylindrical part) and inner valve stem (rim part). The rim part may, in an example, by configured as being detachable from the cylindrical part or outer valve stem. The outer valve part is arranged to receive the valve core, whereas the inner valve part provides access to the inner part of the tyre or also referred to as the air reservoir which is defined as the volume between the rim and the tyre, when the tyre is mounted onto the rim. The inner valve part thus extends at least partly into the air reservoir such that air and sealant, applied via the outer, cylindrical part of the valve stem body, can be passed into the air reservoir.

The valve stem system according the present disclosure comprises two valves, or at least as it is to be defined according to the present disclosure in all aspects and examples thereof, as well as the embodiments shown and described in the figures, two separate valve outlet ports. Hence, the first and second valve are functionally different from each other but may in some way be integrated structurally or may be structurally formed from separate components. What is meant by that is that the first valve may be a distinct component from the second valve and may be manufactured separated thereof. However, these first and second valves may also be partly of fully integrated into each other. Meaning that the first and second valve may engage such that both parts are adjacent each other and further also are both movable in a corresponding manner, e.g. by engaging in such way that the movement of the first valve realised movement of the second valve, but also in a way that both components are fixed and movement is thereby fixed and corresponding as well. Finally, both components may be formed from as a single monolithic part, e.g. by machining, drilling and/or milling it from a single piece of material. In any example of separate first and second valves, partly or fully integrated valves, the valve stem system according to the present disclosure has separate valve ports such that sealant and air enters and exits the air reservoir of the tyre setup at different, distinct positions. This allows each port to be configured for a particular purpose such that it may be specifically arranged, or at least primarily configured for either sealant (valve port of the second valve) or for air (valve port of the first valve).

The cylindrical or outer part of the valve stem body is arranged to receive the valve core to allow air via the first valve in the inner, rim part of the valve stem body to enter the air reservoir. The cylindrical or outer part of the valve stem body is also arranged, when the valve core is not disposed or received therein, to receive a sealant syringe tool, and more particularly, a hose attached to the syringe tool, to enter via or through the second valve port for the sealant to enter into the air reservoir. The second valve is thus a non-return valve which maintains air pressure in the tyre via the second valve while boosting and when the tyre is in normal use, hence, not being boosted, and not being injected with sealant. The first valve is also a non-return valve for maintaining air pressure upon boosting and upon injecting the sealant, hence when no valve core is inserted, however, the first valve is opened to allow air to flow out of the air reservoir through the valve port of the first valve towards the valve core when the valve core is received or inserted into the valve stem.

The two valve ports are separate from each other and have different interface locations with the air reservoir such that injecting the sealant does not clog the interface (valve) for the air and vice versa.

The first valve, for the air, is thus configured to allow air from the valve core into the air reservoir and to this end, the first valve is configured such that upon receiving the valve core, e.g. the Presta valve or interface with a tyre pressure management system, the air passage is open and air can flow from the valve core through the first valve into the air reservoir, whereas the first valve is further configured such that upon removing the valve core, the air passage is closed such that the valve is airtight. In the latter, the valve system may be considered in a sealant modus as the removal of the valve core allows sealant to be injected through the second valve and air prevented from deflating from the air reservoir.

The opening and closing of the first valve is realized by comprising a movable valve body which is disposed in the valve stem body. Hence, the valve stem body is a (partly hollow) cylindrical part which allows the movable first valve to move in a longitudinal direction in the valve stem body. The second valve may be moved accordingly, when the first and second valve are formed as separate parts. In the example of a monolithically formed first and second valve they thus thereby automatically move as one single part. Receiving or inserting the valve core pushes the movable first valve or moveable valve body (and thereby thus also the second valve in an example thereof) into the system and towards the air reservoir, such that the air passage is created and air can flow from the valve core to the air reservoir.

In use, hence, when the wheel is installed and the tyre is on the rim and inflated, the air reservoir holds a certain amount of sealant. The sealant, especially when the wheel start spinning, may come into contact with the vale stem system and especially the first valve thereof. To prevent this first (air) valve to clog from sealant, the first valve is further comprised of a filter or filter unit. The filter unit is disposed between the first valve and the air reservoir and provides an additional barrier or filter to prevent sealant to adhere or enter the valve and valve stem system. The first valve and filter unit also provide a bypass for the second valve upon deflation.

In an example, the second valve is configured as a movable non-return valve body which is disposed in the valve stem body, and configured for longitudinal displacement within the valve stem body trough movement of the first valve.

In an example, the second valve and first valve are arranged to be engaged for correspondingly movement of the first and second valve upon receiving the valve core in the outer valve stem.

In an example, the second valve and first valve are formed from a single monolithic part.

In an example, the filter unit comprises a labyrinth as an air passage between said first valve and said air reservoir.

The filter may be configured as a filter unit contained in a housing and the housing may comprise a labyrinth for the passage of air from and to the valve system, i.e. between the valve core, through the movable inner part and the first valve to the air reservoir. The labyrinth has the advantageous effect that it is more difficult for liquids and even more for particles to enter the valve than it is for air, which is not obstructed by the labyrinth. Especially during deflation the labyrinth may prevent particles and sealant from entering the (first) valve or more exactly the valve port of the first valve. First, the labyrinth avoids or makes it more difficult for liquid and sealant particles to contact the filter material. Second, the filter material will block these particles, however, these particles may deteriorate the hydrophobic properties of the filter material in time.

In an example, the filter unit comprises a sealant-repellent filter for repelling liquid from said filter.

To further increase the filter function, the filter may comprise sealant-repelling means or a sealant-repellent which increases the filter function against sealant, but also against other liquid or liquid-like substances such as water droplets.

In an example, the sealant-repellent comprises a hydrophobic fabric or metallic layer. Whereas the metallic or fabric layer has a certain permeability/porosity for air and not for fluids combined with a low surface tension caused by hydrophobic micro structures on the surface or a surface coating.

To even further increase the filtering, the filter unit may comprise a hydrophobic layer which may be provided as a filter material. The filter unit may thus house a filter made from filter material which occupies part of the volume of the filter unit or a part thereof, and may comprise a single layer or a full monolithic filter part.

In an example, at least a part of the filter unit comprises sealant absorption material configured to absorb sealant.

The filter may comprise a sealant absorption filter which may act as a last resort or final stage of preventing sealant (and/or other liquids) to enter and clog the valve. When the filter for example deteriorates or becomes seized, the filter may be comprised of a sealant absorption layer, segment or part which will absorb the sealant particles and eventually clog in case it is saturated. This will avoid that the sealant will enter the valve stem in case of malfunction. The saturated filter may be used as indicator means for the user to indicate that the filter needs to be replaced, to allow and maintain free passage of air. Due to the indicator means of a saturated filter the clogged filter can be detected and the filter material or filter unit may be replaced which is cheaper than exchanging the hole valve unit. Preferably, the filter may have means to indicate such clogging, e.g. the filter may obtain a different colour or indicator which indicates saturation of the filter.

In an example, the sealant absorption filter is disposed in said filter adjacent said first valve.

The sealant absorption filter is preferably disposed closely to or adjacent the first valve, such that it may function as the final resort to prevent sealant to enter the first valve.

In an example, the valve stem is arranged for receiving a Presta-type valve core.

As indicated, the valve stem system according to the present disclosure may be arranged for an integrated valve core but is preferably arranged to receive a conventional valve core such as a Presta type valve. The valve core will actuate the valve body and the valve body will actuate the first valve and preferably also the second valve. The skilled person will appreciate which other types of valve cores may also be used and suitable.

In an example, the first valve is disposed at said inner valve body in lateral direction of said valve stem body.

In an example, the second valve is disposed at said inner valve body in longitudinal direction of said valve stem body.

In an example, any one or both of said first and second valves are non-return valves.

Preferably, both first and second valves are non-return valves, wherein the first (air) valve is further configured (due to the movable valve body), to be forced into an open condition to allow air to pass the first valve in both directions when the movable valve body is not displaced by the valve core being received and inserted into the valve stem.

In an example, the second valve is configured as an aperture to allow insertion of a sealant application hose through said second valve into said air reservoir.

In an example, the second valve comprises a deformable material, in particular rubber.

The second valve may comprise one single monolithic part or two distinct parts, e.g. the actual valve and a flexible cover as a protective component over the valve. The cover may protect the second non-return valve and movable valve body against sealant and removes sealant from the circumference of the sealant application hose while retracting it from the tyre. The second valve, either in the single or two part configuration described above, may open up upon inserting the sealant application tool, e.g. a syringe with a hose attached to it which may be pushed through the valve, e.g. in an example wherein the valve is formed as a aperture. The second valve may comprise a deformable but preferably durable and rigid material like rubber or the like to prevent sealant from entering the valve stem when the syringe is retracted. The valve may be formed such that under normal conditions, when the tyre is pressurized, the valve may be closed. More preferably, the valve may be arranged for high air pressure, such that it can withstand the air being entered into the air reservoir upon boosting the tyre.

In an example, the filter unit is disposed in a filter housing, and preferably said housing limits movement of said non-return valve body of said first valve.

To limit and define the travel of the movement of the inner part or the first movable non-return valve, the filter housing may be configured as such. This may be achieved by the shape and design of the filter housing which may limit the movable part as a blocking element.

The filter housing thus houses the filter unit and is preferably arranged for accommodating a filter with such filter capacity to minimize the air flow barrier by the filter. To this end, the filter housing may be arranged to accommodate a filter which sufficient air accessible filter surface area, which is encapsuled by the housing to keep sealant away from the filter. The housing is preferably only open at a proximal end of the housing such that air may flow from the open end over the surface area of the filter while being covered by the housing. This way the air flow capacity of the filter is increased, while minimizing the risk of sealant getting on the filter.

In an example, the first filter is configured for longitudinal displacement within said valve stem body upon removing said valve core from said outer valve stem, for said first valve to close and block air passage between said valve core and said air reservoir.

In a second aspect, there is provided, a sealant application tool, comprising a syringe and a sealant application hose for insertion of a sealant from said syringe into a valve stem system according to any of the previous claims.

In a second aspect, the valve stem system according to the first aspect of the present disclosure may receive a sealant application tool for the sealant to be injected into (or even removed from in case of over-dozing of the sealant into the tyre), the air reservoir. The application tool may consist of a syringe in which a sealant is already provided, or which can be filled accordingly (which thus allows re-use of the syringe and refilling it with sealant). The syringe may have a hose which has a cross-sectional diameter which corresponds to the inner diameter of the outer valve stem. The hose may be injected therein to such a degree that it passes the second filter to enter the air reservoir, after which the syringe can be emptied, allowing the sealant to pass to the air reservoir. The valve stem system and sealant application tool may be arranged for standard sealants and comply with standard luer taper connectors as defined in ISO 80369. The valve may have means to guide the sealant application hose through the housing or inner part without the risk of sealant spillage and pollution. The application hose will then protrude the second valve, being preferably a non-return valve, and can be inserted to the required dept for injection of sealant or retraction of sealant to and from the air reservoir.

In a third aspect, there is presented a tubeless tyre setup comprising a valve stem system according to any of the previous descriptions.

In a fourth aspect, there is presented a filter for a valve stem system according to any of the previous descriptions, disposed between said first valve and said air reservoir, to filter sealant from said air reservoir to enter said first valve.

In an example, the filter comprises a labyrinth as an air passage between said first valve and said air reservoir.

In an example, the filter unit further comprises a sealant-repellant filter for repelling liquid from said filter.

In an example, the sealant-repellant comprises a hydrophobic layer.

In an example, the filter comprises a sealant absorption filter configured to absorb sealant.

In an example, the sealant absorption filter is disposed in said filter adjacent said first valve.

In an example, the filter is disposed in a filter housing, and preferably said housing limits movement of said non-return valve body of said first valve.

In an example, the first filter is configured for longitudinal displacement within said valve stem body upon removing said valve core from said outer valve stem, for said first valve to close and block air passage between said valve core and said air reservoir.

In a fifth aspect, there is presented vehicle comprising a tubeless tyre setup according to any of the previous descriptions, wherein in an example, the vehicle is a two-wheeled vehicle or a four-wheeled vehicle, and the vehicle being a bicycle, or a motorized two-wheeled vehicle, in particular a e-bike or motorcycle, or a car.

Any examples, embodiments, advantageous and features of the first aspect of the present disclosure are correspondingly also applicable to the second aspect, the third aspect, the fourth and fifth aspect of the present disclosure.

### BRIEF DESCRIPTION OF THE DRAWINGS

The present disclosure, in all of its aspects, will be more fully understood from the detailed description of the given herein below and the accompanying drawings, which should not be considered as limiting to the invention described in the appended claims.

FIG. 1 shows a valve stem system according to an aspect of the present disclosure;

FIG. 2 shows the valve stem system from a different perspective.

FIG. 3 shows the valve stem system when not-installed on a wheel;

FIG. 4 shows the valve stem system in a exploded view;

FIG. 5 shows the working principle of the valve stem system;

FIG. 6 shows the valve stem system when sealant is injected.

### DETAILED DESCRIPTION OF THE DRAWINGS

The present disclosure, in all of its aspects, will be more fully understood from the detailed description of the given herein below and the accompanying drawings, which should not be considered as limiting to the invention described in the appended claims.

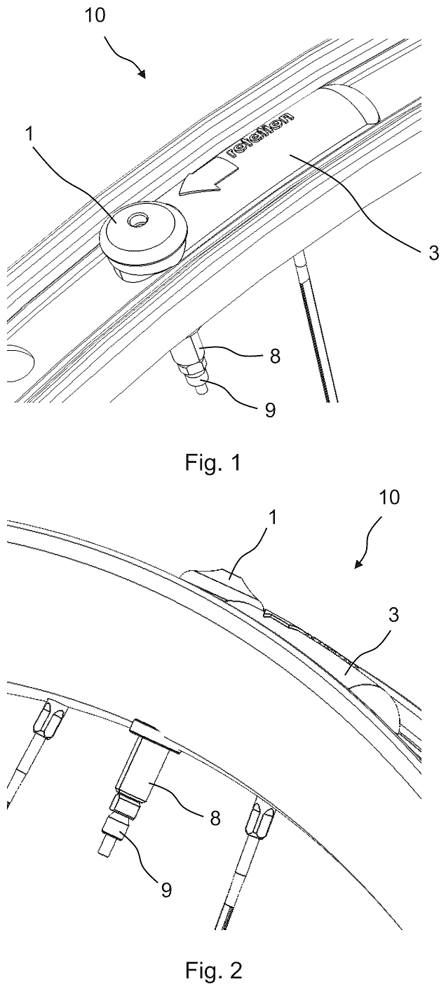

FIG. 1 shows a valve stem system 10 for a tubeless wheel. The wheel comprises a rim and a tyre, together referred to as the tyre setup, as well as several other parts which are less relevant for the present disclosure.

The valve stem system 10 has several main components, the valve stem body 8 has an inner (valve stem) part and an outer (valve stem) part. The outer valve stem part may also be referred to as the cylindrical part of the valve stem, which part is directed towards the wheel hub. The inner valve stem part extends inside the tyre, and thus inside the air reservoir which is defined as the space or the volume between the rim and the tyre when the tyre is mounted on the wheel. The inner valve stem part may also be referred to as the rim part which comprises a cover 1 for the second valve 2, and the filter unit perpendicular to the valve stem body 8, of which filter unit the cover 3 is shown in FIG. 1. On the cover the orientation of installation of the valve stem system 10 is also indicated, i.e. the preferred orientation is that the rim part is oriented opposite of the direction of rotation as indicated with the arrow on the cover 3 of the filter unit. This has the effect that less sealant may enter the filter unit. The direction of the air inlet of the filter unit is opposite to the rotational direction of the tyre setup, such that any splash or spray of sealant particles upon rotation, are kept out of the filter unit.

The outer valve stem is disposed at a first end of the valve stem body and arranged to receive a valve core 9, such as Presta valves or other types of valves or interfaces for such valves. The inner valve body is on the opposite side or second end of the valve stem body and directed towards and extending in the air reservoir between the rim and the tyre.

The two valves or at least the valve outlet thereof are at least partly disposed at the inner valve body or second end of the valve stem body, such that a passages is provided into the air reservoir at different positions. As can be seen on FIG. 1, the filter housing, which is disposed at the outlet of the first valve 4 is directed perpendicular to the longitudinal axis of the valve stem body 8 whereas the cover 1 for the second valve 2 is in line with this longitudinal axis.

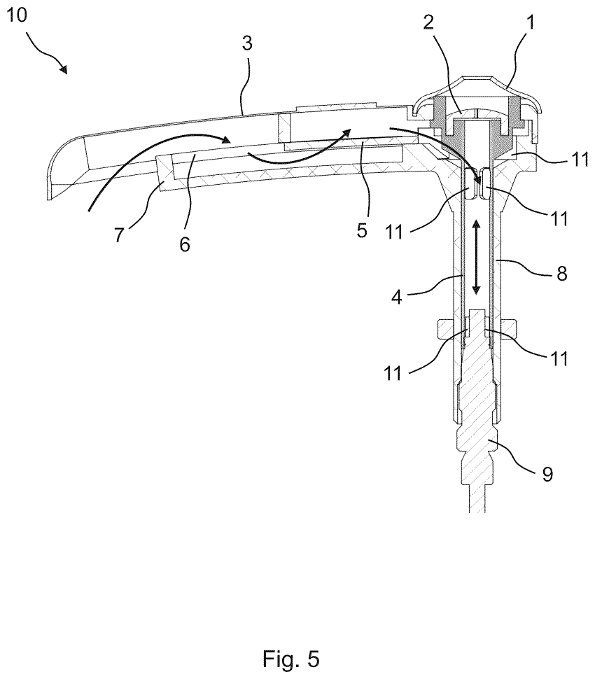

The filter unit (or more precisely the cover 3 of the filter unit) is attached to the first valve 4 (shown in FIGS. 4 and 5) or more precisely, to the valve outlet port of the first valve, which is arranged and configured to allow air to pass between the valve core 9 and the air reservoir. Hence, this valve provides the air passage.

The second valve 2 (shown in FIG. 4 and further) is protected with a cover 1, is separate from the first valve or more precisely, the valve outlet port of the first valve is separate from the valve outlet port of the second valve 2. The second valve is configured to allow sealant to pass between the outer valve stem and the air reservoir.

To prevent sealant to enter, limit or even clog the first valve 4, the valve outlet port of the first valve 4 may be comprised of a filter. The filter is disposed between the valve outlet port of the first valve and the air reservoir, meaning that it provides a barrier adjacent the air entrance into the valve stem body to filter and prevent sealant from the air reservoir to enter the valve stem system through the valve outlet port and the first valve.

The valve system is configured such that the first valve has an outer valve opening or exit and an inner movable valve body part which is disposed within the valve stem body 8, mostly within the outer valve stem 8, or cylindrical part 8, and preferably partly within the inner valve stem or rim part 1, 3.

The (inner) movable valve body is a non-return valve and arranged to move in the longitudinal direction within the valve stem body 8 in such a way that in a first position the valve is open and in a second position the valve is closed. The valve may be closed when the valve core 9 is removed and the movable valve body is displaced outward of the valve stem system in the direction of the wheel hub, whereas the valve may be opened when the valve core 9 is in position in the valve stem body and the movable valve body is displaced inwardly of the valve stem system in the direction of the wheel hub. When the tyre setup is inflated through a so called boosting procedure (in which a certain volume of air is pumped into the air reservoir of the tyre setup at high pressure in a relative short time), the movable first non-return valve opens as a result of the air pressure such that air from a booster container or tank can enter the air reservoir through the first and the second valve 2. The valve stem system may have further means to force the movable valve body in the first or second position when no force is applied by the valve core, e.g. by a spring or other tension means.

In FIG. 2 the valve stem system 10 is shown from another perspective view wherein the valve stem body 8 and the valve core 9 are clearly shown and from which it is clear that the valve core 9 is received in the valve stem body 8 or more particularly the outer valve stem in a conventional manner. The other parts 1, 3 of the valve stem system 10 are disposed inside of the wheel and may have a shape corresponding to the rim or a section of the rim, e.g. in length, size and curvature.

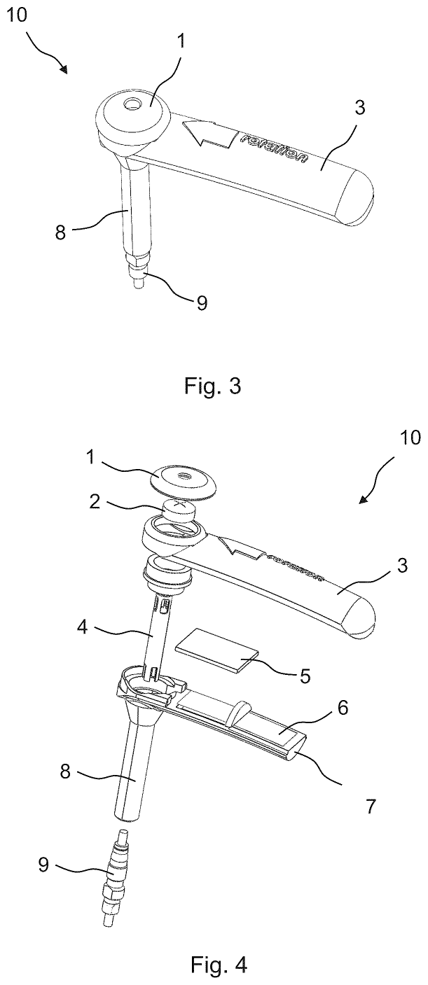

FIG. 3 shows the valve stem system 10 according to the present disclosure as a complete but non-installed manner which also clearly shows that the system has a longitudinal, cylindrical part 8, to receive therein the valve core 9, and a perpendicular part inside the tyre setup in which the outlets of the first and second valves end, and in which the first valve outlet is provided with a filter housing, protected by a cover 3, such that the air may enter and exit perpendicular to the cylindrical part 8, whereas the sealant may injected (and be removed from if applicable) through the cover 3 in line with the cylindrical part.

In FIG. 4 shows several parts of the valve stem system 10 according to the present disclosure. One of the main housing parts is the valve stem body 8, which provides an appropriate interface for a nut that is used to firmly fix and seal the valve unit inside the rim. It also hold the interface for a standardized valve core such as the Presta valve 9 or other valve cores (not shown), or such as any interface for a tyre pressure management system. The valve stem body 8 may be dimensioned according to the application, e.g. having a dimension and corresponding nut interface for a standard bicycle tyre, (bicycle) race tyre, motorcycle tyre, car tyre or any other tyre setup for a wheeled vehicle.

Inside the main housing or valve stem body 8 the first valve 4 is configured as the movable valve body which allows free passage of air in case of inflation but will close upon removal of a pressure source at the inlet or removal of the valve core 9. The movable (inner) body of the first valve is arranged to move freely inside the housing 7 of the filter unit and the valve stem body 8. The driving force of the movement of the inner valve body is the pressure difference between the inlet pressure (ambient pressure) and the tyre pressure. The movable inner valve body can be forced to open in case an element like a Presta valve 9 is inserted into the valve stem body 8 and touches the lower part of the movable valve body 8, or in particular a flange, collar or rim thereof.

Adjacent to the longitudinal axis of the housing part being perpendicular to the longitudinal axis of the valve stem body 8, is the protective cover 3. The cover 3 forms a closure for the housing 7 of the filter unit and filter units 5, 6 made of filter material disposed in the filter housing 7, and the outlet or port of the first valve 4. The protective cover 3 creates, together with the housing 7 of the filter a labyrinth for the air that leaves the tyre during deflation. With such housing, cover and labyrinth sealant particles will be kept away from the sealant filter 6 during deflation but also at normal use of the tyre setup, i.e. when no deflation, inflation or boosting takes place. The cover thus also creates a direct protection against sealant droplets or spray that might contact the sealant filter 6. Direct contact of the sealant filter with sealant droplets will deteriorate the filter properties. Additionally, the cover will protect the unit from impact in case the tyre is compressed, exactly at the position of the valve unit, under impact, for instance while riding on rocky terrain. Furthermore the cover will hold the (movable) valve body and may limit the movement of it.

The housing 7 and cover 3 thus enclose the filter unit 5, 6 and filter material inside thereof which filter unit may be formed by the labyrinth inside the housing, but also comprising a sealant absorption filter 5. In case of a deteriorated sealant filter 6 or a malfunction/defect of the system, this filter 5 will absorb sealant particles and will eventually clog in case it is completely saturated. This will avoid that sealant will enter the valve stem body in case of a malfunction and may even indicate to the user that the filter unit needs to be exchanged because free passage of air is obstructed. The filter unit may comprise a sealant repelling filter part 6. This filter 6 has liquid repelling properties creating a low surface tension, to provide low attraction of liquids or even repel liquids. The cohesion forces/surface tension inside the sealant are much higher and the sealant particles cannot pass the small openings inside the filter at the given pressure drop across the filter during deflation. During inflation sealant droplets on the filter are washed away by the driving force of the air pressure. Contact between the filter and sealant particles can to be avoided by means of the protective cover 3, because contact may deteriorate the hydrophobic properties of the filter and will lead to a shorter lifetime, due to the chemicals inside the sealant, and additives that reduce the surface tension of the sealant, in order to improve the sealing properties of the sealant (increase adhesion to the tyre).

At the proximal end of the system 10 the second valve 2 is disposed such that the valve outlet ports is adjacent the air reservoir. This valve functions as the sealant non-return valve that opens upon insertion of a sealant application hose but closes upon retraction of the sealant application hose. This way it avoids ingress of sealant during normal operation. The valve 2, may have a flexible cover 1, which is attached to the protective cover 3 of the housing 7 and protects the movable valve body against sealant and removes sealant from the circumference of a sealant application hose while retracting this from the tyre.

FIG. 5 shows a cross-sectional view of the valve stem system 10 according to the present disclosure. It also shows how the air may flow during deflation through the housing 7 and protective cover 3 through its air labyrinth disposed therein, and through the two filter parts 5, 6. The air flows into the movable valve body which is configured as the non-return valve or movable valve body of the first valve 4 which can thus move up and down into the outer part of the valve stem body 8. The movement is forced by the insertion of a valve core such as a Presta valve 9 such that air gaps 11 allow air to pass between the valve core 9 and the inlet of air indicated with the arrow at the open end of the housing 7 and cover 3.

FIG. 5 also shows the sealant non-return valve which is used to inject or insert clean sealant (liquid or liquid-like substance) through the second valve 2 and through the protective cover 1 of the second valve 2, directly into the air reservoir.

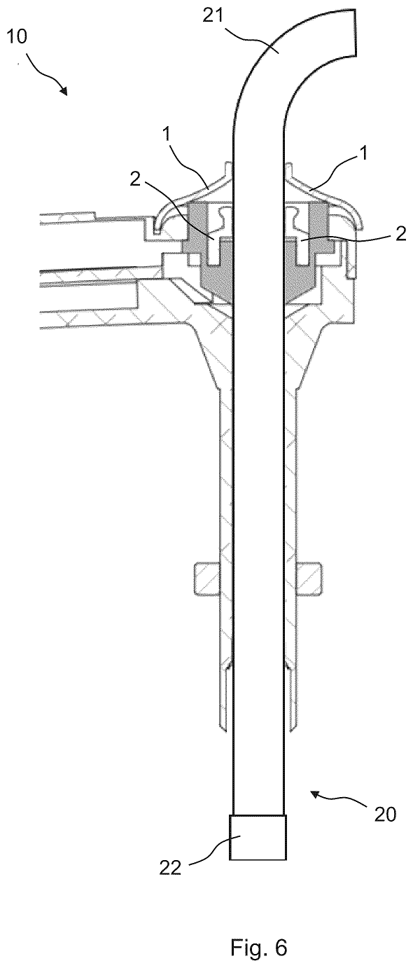

In FIG. 6 a valve stem system 10 is shown when a sealant application tool 20 is used to inject sealant into the air reservoir. The sealant application tool 20 may comprise a syringe 22 (partly not shown) and a sealant application hose 21 which is passed through the inner section of the movable valve stem 4, and through the second valve 2 and through its protective cover 1, so an open end of the hose 21 is in direct contact with the air reservoir to allow sealant to enter the air reservoir or even remove sealant thereof, if necessary.

The ensuing description above provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention, it being understood that various changes may be made in the function and arrangement of elements, including combinations of features from different embodiments, without departing from the scope of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application.

Where the context permits, words in the detailed description using the singular or plural number may also include the plural or singular number respectively. The word “or,” in reference to a list of two or more items, covers all of the following interpretations of the word: any of the items in the list, all of the items in the list, and any combination of the items in the list.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. Details of the system may vary considerably in its specific implementation, while still being encompassed by the technology disclosed herein.

As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while some aspect of the technology may be recited as a computer-readable medium claim, other aspects may likewise be embodied as a computer-readable medium claim, or in other forms, such as being embodied in a means-plus-function claim.

In the description above, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

1-26. (canceled)

27. A valve stem system for a tubeless tire setup for a wheel including a rim and a tire, the valve stem system comprising:
a valve stem body comprising at a first end an outer valve stem configured to receive a valve core, and at a second end an inner valve body extending in an air reservoir defined between the rim and the tire mounted on the wheel;
a first valve, comprising a valve outlet port at the inner valve body, configured to allow air passage between the outer valve stem and the air reservoir;
a second valve, comprising a valve outlet which, at the inner valve body, separate from the outlet port of the first valve, configured to allow sealant passage from the outer valve stem into the air reservoir; and
a filter disposed between the first valve and the air reservoir, the filter configured to filter sealant entering the first valve from the air reservoir;
wherein the first valve is a movable non-return valve body disposed in the valve stem body, and is configured for longitudinal displacement within the valve stem body upon receiving the valve core in the outer valve stem, for the first valve to open and allow air passage between the valve core and the air reservoir.

28. The valve stem system according to claim 27, wherein the second valve is a movable non-return valve body disposed in the valve stem body, and is configured for longitudinal displacement within the valve stem body through movement of the first valve.

29. The valve stem system according to claim 28, wherein the second valve and the first valve are configured to be engaged for corresponding movement of the first and second valve upon receiving the valve core in the outer valve stem.

30. The valve stem system according to claim 28, wherein the second valve and the first valve are formed from a single monolithic part.

31. The valve stem system according to claim 27, wherein the filter comprises a labyrinth as an air passage between the first valve and the air reservoir.

32. The valve stem system according to claim 27, wherein the filter further comprises a sealant-repellent filter configured to repel liquid from the filter.

33. The valve stem system according to claim 32, wherein the sealant-repellent filter comprises a hydrophobic layer.

34. The valve stem system according to claim 27, wherein the filter comprises a sealant-absorbing filter configured to absorb sealant.

35. The valve stem system according to claim 34, wherein the sealant-absorbing filter is disposed in the filter adjacent to the first valve.

36. The valve stem system according to claim 27, wherein the valve stem body is configured to receive a Presta-type valve core.

37. The valve stem system according to claim 27, wherein the first valve is disposed at the inner valve body in a lateral direction of the valve stem body.

38. The valve stem system according to claim 27, wherein the second valve is disposed at the inner valve body in a longitudinal direction of the valve stem body.

39. The valve stem system according to claim 27, wherein one or more of the first and second valves are non-return valves.

40. The valve stem system according to claim 27, wherein the second valve is configured as an aperture to allow insertion of a sealant application hose through the second valve into the air reservoir.

41. The valve stem system according to claim 27, wherein the second valve comprises an elastically deformable material.

42. The valve stem system according to claim 27, wherein the filter is disposed in a filter housing configured to limit movement of the non-return valve body of the first valve.

43. The valve stem system according to claim 27, wherein the filter is configured for longitudinal displacement within the valve stem body upon removing the valve core from the outer valve stem, for the first valve to close and block air passage between the valve core and the air reservoir.

44. The valve stem system according to claim 27, for use on a vehicle.

45. The valve stem system according to claim 44, wherein the vehicle is an e-bike, a motorcycle, or a car.
